(19) United States
(12) Patent Application Publication
(10) Pub. No.: US 2021/0225601 A1
(43) Pub. Date: Jul. 22, 2021

(54) KEY SWITCH WITH PRESSURE BALANCE FUNCTION

(71) Applicant: Dongguan City Kaihua Electronics Co., Ltd, Dongguan, Guangdong (CN)

(72) Inventor: FuXi WU, Dongguan, Guangdong (CN)

(21) Appl. No.: 17/055,611

(22) PCT Filed: Jun. 20, 2019
(86) PCT No.: PCT/CN2019/092045

§ 371 Date: Nov. 16, 2020

(30) Foreign Application Priority Data
May 24, 2018 (CN) 201820785828.6

(51) Int. Cl. H01H 13/20; H01H 13/14; H01H 13/10

(52) U.S. Cl. CPC H01H 13/20; H01H 2233/07; H01H 13/10; H01H 13/14

(57) ABSTRACT

A keyboard switch with a pressure balance function, including a base, a key cap arranged on the base, and a pressure balance assembly arranged between the base and the key cap. Wherein, the pressure balance assembly includes a balance bracket A connected between the base and the key cap, a balance bracket B connected between the base and the key cap, and an elastic member connected between the balance bracket A and the balance bracket B. The keyboard switch of the present disclosure provides excellent pressing balance and stability, which significantly increases pressing stroke and enhances pressing feeling.

### CROSS REFERENCES TO RELATED APPLICATIONS

This application is a continuation of International patent Application No. PCT/CN2019/092045 filed on Jun. 20, 2019, which claims foreign priority of Chinese Patent Application No. 201820785828.6, filed on May 24, 2018 in the State Intellectual Property Office of China, the disclosures of all of which are hereby incorporated by reference.

### TECHNICAL FIELD

The present disclosure relates to a key switch, in particular to a key switch with a pressure balance function.

### BACKGROUND

Many operations of the existing equipment need to use the key switch as the input means. The quality of the key switch determines the experience of the input device, which needs to ensure a good handle and service life. At the same time, the stability of the key switch in the use process also has high requirements, and there must be no jam. However, these technical problems are in the process of continuous improvement, but still not ideal.

During the pressing process of the existing key switch, especially when pressing the corner, due to the structural limitation, the internal structures are not closely matched, the interaction is not coordinated, the balance is poor, the pressing is not smooth and the stability is poor, so the pressing jam feeling often occurs, which affects the normal use and the feeling of pressing.

### SUMMARY

In view of the above defects, the present disclosure aims to provide a key switch with pressing balance function, which has good pressing balance and stability, significantly increases the pressing stroke and improves the pressing feel.

The technical solution adopted by the present disclosure to achieve the above objective is as follows:

A key switch with pressure balance function, including a base and a key cap arranged above the base, a press balance assembly arranged between the base and the key cap, wherein the press balance assembly includes a balance bracket A connected between the base and the key cap, a balance bracket B connected between the base and the key cap, and an elastic member connected between the balance bracket A and the balance bracket B.

As a further improvement of the present disclosure, the elastic member is a tension spring.

As a further improvement of the present disclosure, the balance bracket A and the balance bracket B are not connected.

As a further improvement of the present disclosure, the balance bracket A and the balance bracket B are connected in a flexible connection way.

As a further improvement of the present disclosure, the balance bracket A and the balance bracket B are connected by flexible glue.

As a further improvement of the present disclosure, both the balance bracket A and the balance bracket B are in a U-shaped structure, and an U-shaped open end of the balance bracket A is opposite to an U-shaped open end of the balance bracket B; structures of the balance bracket A and the balance bracket B are the same, including a transverse balance portion and a longitudinal balance portion connected to both ends of the transverse balance portion, respectively.

As a further improvement of the present disclosure, at least one insertion block is arranged at an outer end of the longitudinal balance portion; a mounting arm is respectively arranged at edges of both sides of the base, and a socket for inserting the insertion block is provided on the mounting arm.

As a further improvement of the present disclosure, two ends of the transverse balance portion are respectively provided with a inserting shaft, and corners of a lower end surface of the key cap are respectively provided with slots for inserting the inserting shaft; at the same time, a hook hole is provided at an inner side of the transverse balance portion for an end of the elastic body to be hooked.

As a further improvement of the present disclosure, the key switch further includes a conduction assembly.

As a further improvement of the present disclosure, the conduction assembly includes a static piece inserted on the base and a movable piece inserted on the base and extending above the static piece; wherein the movable piece comprises an insertion portion inserted on the base, a contact portion connected to an upper end of the insertion portion and vertically bent to one side, and a pressing portion connected to an end of the contact portion and extending upward; a static contact point is arranged on an upper end surface of the static piece, the contact portion is located above the static piece, and a movable contact point corresponding to the static contact point is arranged on the lower end face of the contact portion; a wall is protruded upward on the upper end surface of the base, and an installation groove for inserting the static piece and the movable piece is formed in the wall, and the pressing portion of the movable piece extends above the upper portion of the wall; a cover plate is arranged on the installation groove and above the contact portion of the movable piece.

As a further improvement of the present disclosure, a PCB (printed circuit board) is arranged at the lower end of the base, the conduction assembly includes a photoelectric transmitting tube and a photoelectric receiving tube respectively arranged on the PCB and upper ends of the photoelectric transmitting tube and the photoelectric receiving tube are embedded in the base; a bump is arranged downward at the lower end surface of the key cap.

As a further improvement of the present disclosure, a support base is protruded upward provided on an upper end surface of the base, two embedded slots extending into the support base are arranged on a lower end surface of the base for upper ends of the photoelectric transmitting tube and the photoelectric receiving tube to be embedded; an upper end surface of the support base is provided with a through hole, wherein the through hole passes through the lower end surface of the base and is configured for the bump to be movably inserted up and down; the through hole is located between the two embedded slots, and a punching hole is respectively provided between the two embedded slots and the through hole.

The advantageous effects of the present disclosure are as follows:
(1) The balance bracket A is not connected with the balance bracket B or the balance bracket A is connected with the balance bracket B by flexible connection as the pressing balance assembly. The combination of balance bracket A and the balance bracket B swing up and down to counteract the component force of the pressing pressure in the inclined direction, so that the force of the key is always balanced, and the overall pressing balance is improved, the internal structure functions coordinately which has good balance, smoothly pressing, high stability, no pressing jam feeling and smooth use, such that the pressing feel is significantly improved.
(2) By connecting a tension spring between the balance bracket A and the balance bracket B, it can not only provide the elastic restoring force for the pressing conduction function, but also provide the pulling force for the upward swing of the balance bracket A and the balance bracket B, that is to say, providing the elastic restoring force for the up and down swing of the balance bracket A and the balance bracket B, so as to ensure the accuracy and stability of the up and down swing motion of the balance bracket A and the balance bracket B, further improving the pressing balance. At the same time, the balance bracket A and the balance bracket B are pulled by the tension, which significantly increases the pressing stroke and improves the pressing feel.

The above is an overview of the technical solution of the present disclosure. The present disclosure is further described in combination with the attached drawings and specific embodiments.

### BRIEF DESCRIPTION OF THE DRAWINGS

FIG. 1 is an exploded view of the first embodiment;

FIG. 2 is a partial structural diagram of the first embodiment;

FIG. 3 is a structural diagram of the pressing balance assembly in the first embodiment;

FIG. 4 is a structural diagram of the flexible connection between the balance bracket A and the balance bracket B in the first embodiment;

FIG. 5 is a structural diagram of the base in the first embodiment;

FIG. 6 is a structural diagram of the key cap in the first embodiment;

FIG. 7 is a structural diagram of the moving plate in the first embodiment;

FIG. 8 is a structural diagram showing of the overall external structure of the first embodiment;

FIG. 9 is an exploded view of the second embodiment;

FIG. 10 is a partial structural diagram of the second embodiment;

FIG. 11 is a structural diagram of the key cap in the second embodiment;

FIG. 12 is a structural diagram of the back of the base in the second embodiment;

FIG. 13 is a structural diagram showing of the overall external structure of the second embodiment.

### DETAILED DESCRIPTION OF THE EMBODIMENTS

In order to further elaborate the technical means and effect of the present disclosure to achieve the predetermined objective, the specific embodiments of the present disclosure is described in detail in combination with the attached drawings and preferred embodiments.

### Embodiment 1

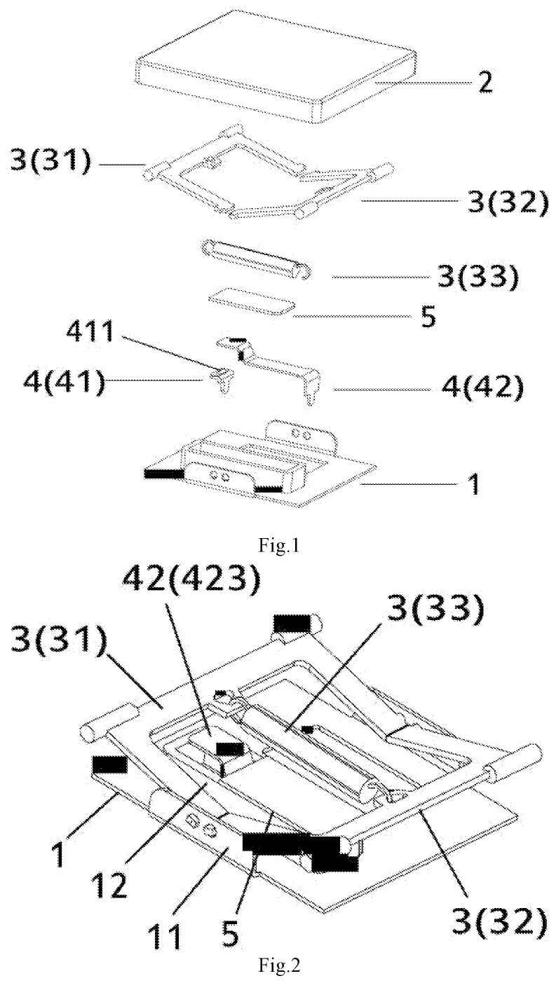

Referring to FIG. 1, FIG. 2 and FIG. 8, this embodiment provides a key switch with pressure balance function, including a base 1, a key cap 2 arranged above the base 1, and a press balance assembly 3 arranged between the base 1 and the key cap 2, wherein the press balance assembly 3 includes a balance frame A 31 connected between the base 1 and the key cap 2, and a The balance frame B 32 connected between the base 1 and the key cap 2, and an elastic member connected between the balance frame A 31 and the balance frame B 32. Preferably, the a elastic member is a tension spring 33.

In the process of turn on of the key switch, no matter which position is pressed on the key cap 2, the balance frame A 31 and the balance frame B 32 swing up and down to counteract the component force of pressing pressure in the inclined direction, so that the force on the key is balanced and the overall pressing balance force is improved. At the same time, the tension spring 33 provides elastic restoring force for the up and down swing of the balance frame A 31 and the balance frame B 32, and the upward swing action of the balance frame A 31 and the balance frame B 32 is pulled up by the tension spring 33 to prevent the balance frame A 31 and the balance frame B32 from deviating from the original swing track, so as to further improve the pressing balance force. In addition, by pulling the balance frame A and the balance frame B by the tension spring, the pressing stroke is significantly increased, and the pressing feel is improved.

In the present embodiment, the balance frame A 31 is not connected with the balance frame B 32. As shown in FIG. 1 to FIG. 3, when the key cap 2 is pressed down, the balance frame A 31 and the balance frame B 32 can swing respectively to maintain the pressing balance. Of course, the balance frame A 31 and the balance frame B32 in the embodiment can also be connected by flexible connection, as shown in FIG. 4. Specifically, the flexible glue is used to connect the balance frame A 31 and the balance frame B 32, so that the balance frame A 31 and the balance frame B 32 are integrated as one body. When the key cap 2 is pressed down, since the flexible connection between the two can produce flexible deformation at the connection position, it can still be ensured that the balance frame A 31 and the balance frame B 32 can the swing respectively to keep the press balance.

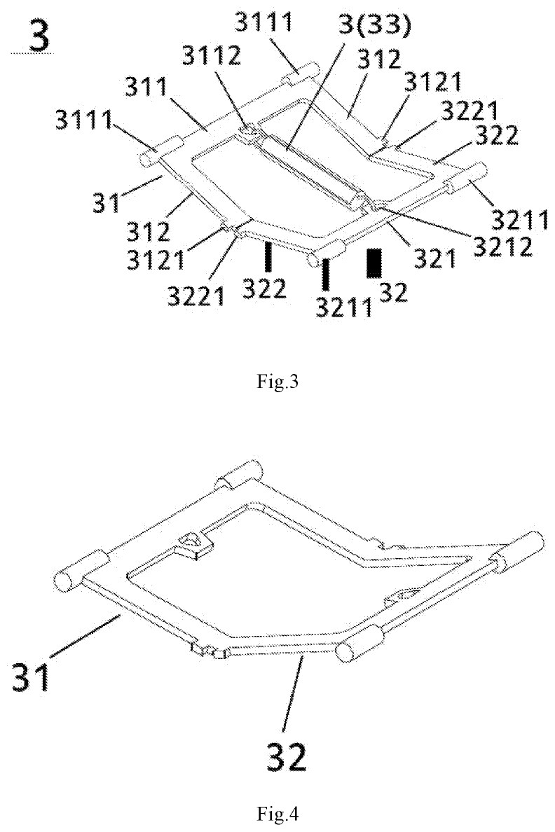

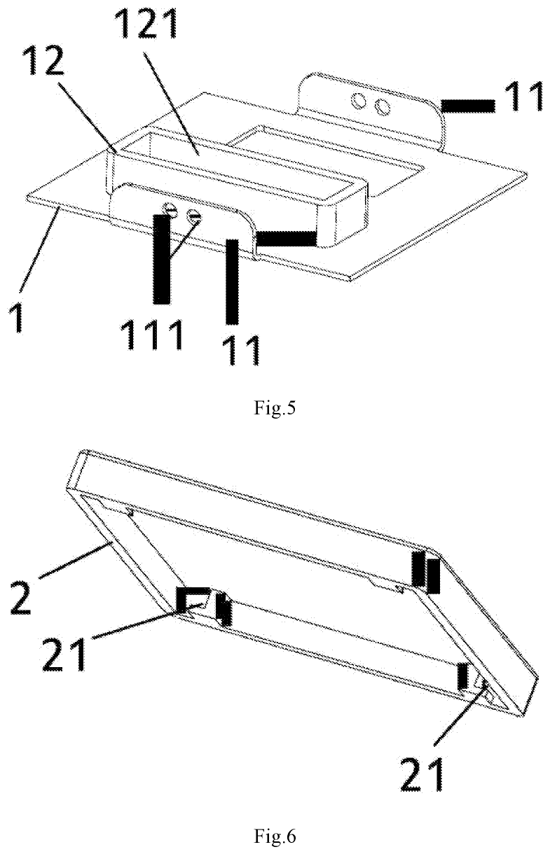

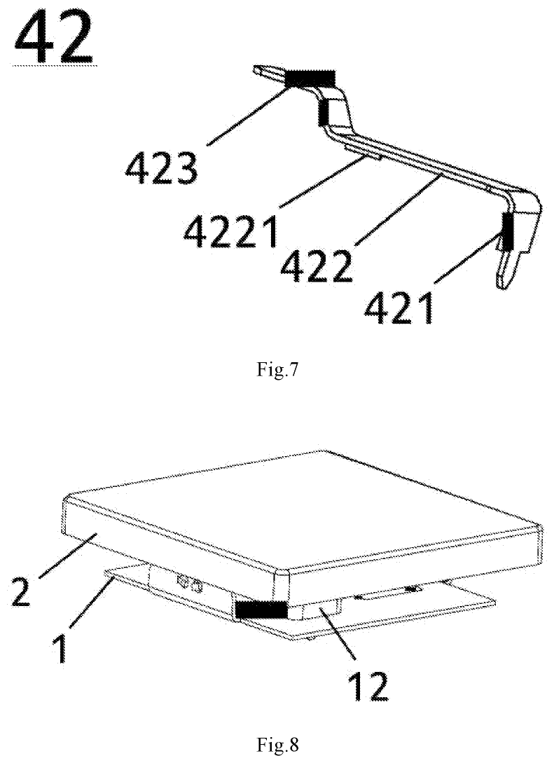

In the present embodiment, as shown in FIG. 3, both the balance frame A 31 and the balance frame B 32 are in a U-shaped structure, and the U-shaped open end of the balance frame A 31 is opposite to the U-shaped open end of the balance frame B 32. The structures of the balance frame A 31 and the balance frame B 32 are the same, which respectively include a transverse balance portion (311, 321) and a longitudinal balance portion (312, 322) connected to both ends of the transverse balance portion (311, 321), respectively. Wherein, the two ends of the transverse balance portion (311, 321) are respectively provided with a inserting shaft (3111, 3211) which is inserted into key cap 2, and a hook hole (3112, 3212) is provided at the inner side of the transverse balance portion (311, 321) for the end of the tension spring 33 to be hooked. At least one insertion block (3121, 3221) is arranged at the outer end of the longitudinal balance portion (312, 322). Accordingly, as shown in FIG. 6, and the corners of the lower end surface of the key cap 2 are respectively provided with slots 21 for inserting the inserting shaft (3111, 3211). As shown in FIG. 2 and FIG. 5, the base 1 of the present embodiment is a single-chip base plate, the edges of both sides of the single-chip substrate are respectively extended upward to provide a mounting arms 11, and a socket 111 for inserting the inserting block (3121, 3221) is arranged on the mounting arm 11.

The upper and lower ends of the balance frame A 31 and the balance frame B 32 are respectively limited by the coordination of the base 1 and the key cap 2. When the key cap 2 is pressed down, the balance frame A 31 and the balance frame B 32 swing up and down to obtain the pressing balance. And the tension spring pulls the balance frame A and the balance frame B, which significantly increases the pressing stroke and improves the pressing feel.

In the present embodiment, the key switch also includes a conduction assembly 4. In this embodiment, the mechanical conduction mode is adopted to realize the on and off functions of the key switch. Specifically, the conduction assembly 4 includes a static piece 41 inserted on the base 1 and a movable piece 42 inserted on the base 1 and extending above the static piece 41. Wherein, the movable piece 42 includes an insertion portion 421 inserted on the base 1, a contact portion 422 connected to the upper end of the insertion portion 421 and vertically bent to one side, and a pressing portion 423 connected to the end of the contact portion 422 and extending upward. A static contact point 411 is arranged on the upper end surface of the static piece 41, the contact portion 422 is located above the static piece 41, and a movable contact point 4221 corresponding to the static contact point 411 is arranged on the lower end surface of the contact portion 411. A wall 12 is protruded upward on the upper end surface of the base 1, and an installation groove 121 for inserting the static piece 41 and the movable piece 42 is formed in the wall 12, and the pressing portion 423 of the movable piece 42 extends above the upper portion of the wall 12, so as to ensure that the key cap 2 can touch the pressing portion 423 when the key cap 2 is pressed downward, such that the accurate press conduction function is achieved.

At the same time, as shown in FIG. 2, a cover plate 5 is arranged on the installation groove 121 and above the contact portion 422 of the movable piece 42. The cover plate 5 plays a certain limiting function on the contact portion 422 of the movable piece 42, so as to prevent the movable piece 42 from springing too much, and ensure that the contact portion 422 bounces in the installation groove 121, so as to improve the accuracy of pressing on and off.

When the key cap 2 is pressed down, the key cap 2 exerts a downward force on the pressing portion 423 on the movable piece 42, so that the pressing portion 423 drives the contact portion 422 to move down, then the movable contact point 4221 on the lower end surface of the contact portion 422 contacts with the static contact point 411 on the static piece 41, so that the key switch is turned on, and the tension spring 33 is deformed. When the pressing pressure on the key cap 2 is released, under the elastic restoring force of the tension spring 33, the key cap is to move up and reset, then the force on the pressing portion 423 of the movable piece 42 is disappeared, so as to make the pressing portion 423 drive the contact portion 422 to move up and reset, causing the movable contact point 4221 is separated from the static contact point 411, and the the key switch is disconnected and turned off.

### Embodiment 2

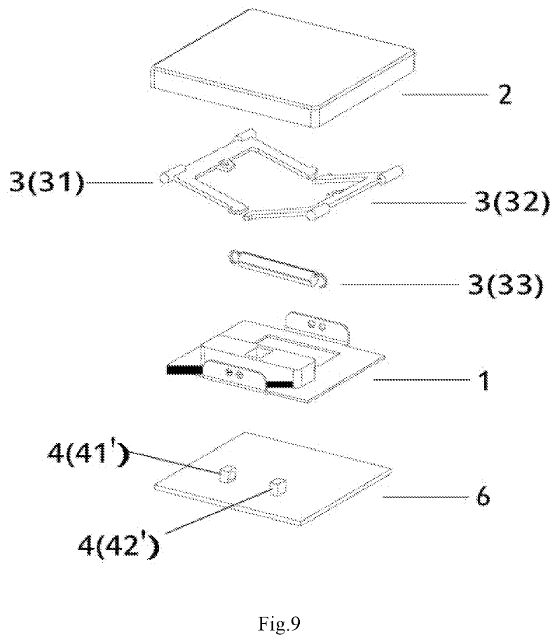

The main difference between the present embodiment and the first embodiment is that the photoelectric conduction mode is adopted to realize the on and off functions of the key switch, so the specific structure of the conduction assembly 4 is different. Correspondingly, the corresponding structures arranged on the base 1 and the key cap 2 are also different, but the specific structure of the press balance assembly 3 is the same. Specifically, as shown in FIG. 9 to FIG. 13, a PCB 6 is arranged at the lower end of the base 1, and the conduction assembly 4 includes a photoelectric transmitting tube 41′ and a photoelectric receiving tube 42′ respectively arranged on the PCB 6 and the upper ends of the photoelectric transmitting tube 41′ and the photoelectric receiving tube 42′ are embedded in the base; a bump 22 is arranged downward on the lower end surface of the key cap 2, as shown in FIG. 11.

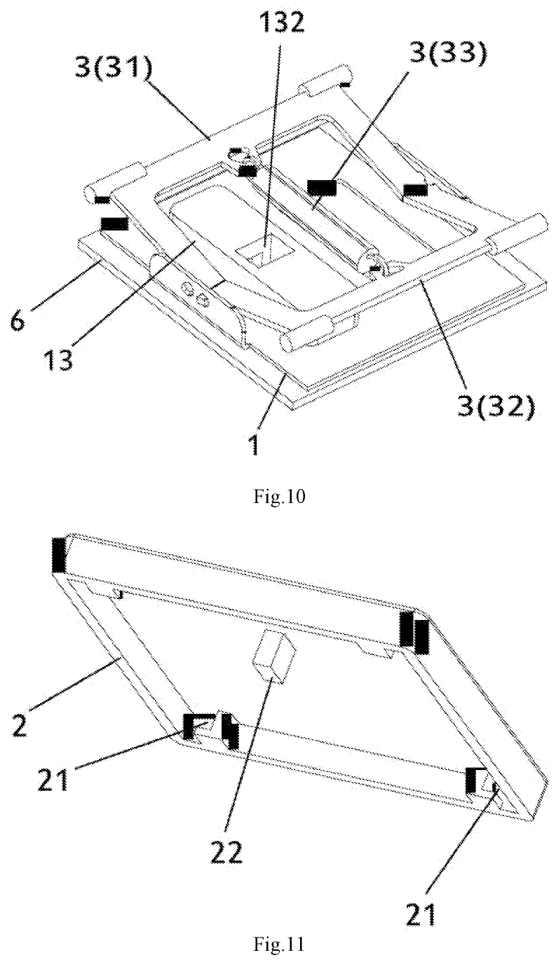

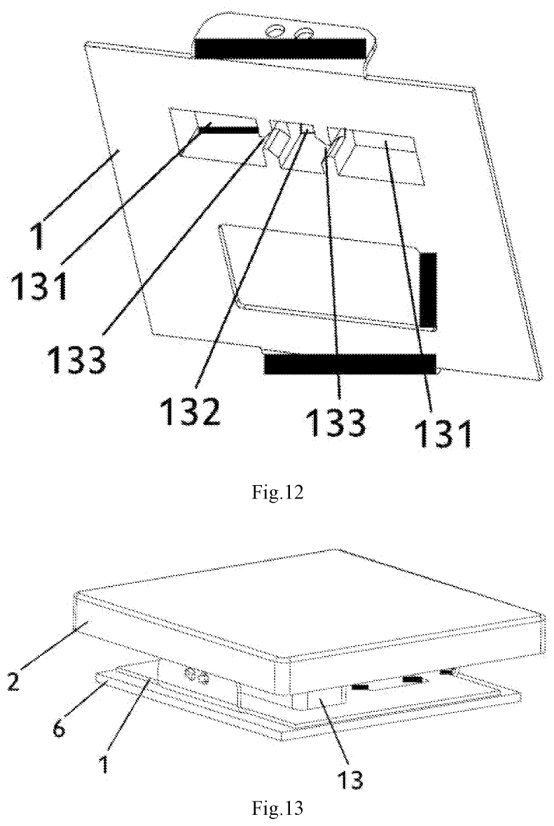

At the sane time, as shown in FIG. 10, FIG. 12 and FIG. 13, a support base 13 is protruded upward provided on an upper end surface of the base 1, two embedded slots 131 extending into the support base 13 are arranged on a lower end surface of the base 1 for the upper ends of the photoelectric transmitting tube 41′ and the photoelectric receiving tube 42′ to be embedded. An upper end surface of the support base 13 is provided with a through hole 132, wherein the through hole 132 passes through the lower end surface of the base 1 and is configured for the bump 22 to be movably inserted up and down. The through hole 132 is located between the two embedded slots 131, and a punching hole 133 is respectively provided between the two embedded slots 131 and the through hole 132.

When the key cap 2 is pressed down, the key cap 2 moves down to drive the bump 22 on the lower end surface of the key cap 2 to move down along the through hole 132, so that the bump 22 is blocked between the photoelectric transmitting tube 41′ and the photoelectric receiving tube 42′. Then the photoelectric receiving tube 42′ cannot receive the photoelectric signal emitted by the photoelectric transmitting tube 41′, then the key switch is turned on, meanwhile, the tension spring 33 is deformed. when the pressing pressure on the key cap 2 is released, the key cap 2 will moves up and reset under the elastic restoring force of the spring 33, driving the bump 22 on the lower end surface of the key cap 2 to move up along the through hole 132. And there is no more blocking thing between the photoelectric transmitting tube 41′ and the photoelectric receiving tube 42′, then the photoelectric receiving tube 42′ receives the photoelectric signal emitted by the photoelectric transmitting tube 41′, and the key switch is disconnected.

The above is only a preferred embodiments of the present disclosure and does not limit the technical scope of the present disclosure. Therefore, other structures obtained by adopting the same or similar technical features as the above-mentioned embodiments of the present disclosure are within the scope of the present disclosure.

What is claimed is:

1. A key switch with pressure balance function, comprising a base and a key cap arranged above the base, a press balance assembly arranged between the base and the key cap, wherein the press balance assembly comprises a balance bracket A connected between the base and the key cap, a balance bracket B connected between the base and the key cap, and an elastic member connected between the balance bracket A and the balance bracket B.

2. The key switch with pressure balance function according to claim 1, wherein the elastic member is a tension spring.

3. The key switch with pressure balance function according to claim 1, wherein the balance bracket A and the balance bracket B are not connected.

4. The key switch with pressure balance function according to claim 1, wherein the balance bracket A and the balance bracket B are connected in a flexible connection way.

5. The key switch with pressure balance function according to claim 4, wherein the balance bracket A and the balance bracket B are connected by flexible glue.

6. The key switch with pressure balance function according to claim 1, wherein both the balance bracket A and the balance bracket B are in a U-shaped structure, and an U-shaped open end of the balance bracket A is opposite to an U-shaped open end of the balance bracket B; structures of the balance bracket A and the balance bracket B are the same, comprising a transverse balance portion and a longitudinal balance portion connected to both ends of the transverse balance portion, respectively.

7. The key switch with pressure balance function according to claim 6, wherein at least one insertion block is arranged at an outer end of the longitudinal balance portion; a mounting arm is respectively arranged at edges of both sides of the base, and a socket for inserting the insertion block is provided on the mounting arm.

8. The key switch with pressure balance function according to claim 6, wherein two ends of the transverse balance portion are respectively provided with a inserting shaft, and corners of a lower end surface of the key cap are respectively provided with slots for inserting the inserting shaft; at the same time, a hook hole is provided at an inner side of the transverse balance portion for an end of the elastic body to be hooked.

9. The key switch with pressure balance function according to claim 1, wherein the key switch further comprises a conduction assembly.

10. The key switch with pressure balance function according to claim 9, wherein the conduction assembly comprises a static piece inserted on the base and a movable piece inserted on the base and extending above the static piece; wherein the movable piece comprises an insertion portion inserted on the base, a contact portion connected to an upper end of the insertion portion and vertically bent to one side, and a pressing portion connected to an end of the contact portion and extending upward; a static contact point is arranged on an upper end surface of the static piece, the contact portion is located above the static piece, and a movable contact point corresponding to the static contact point is arranged on the lower end face of the contact portion; a wall is protruded upward on the upper end surface of the base, and an installation groove for inserting the static piece and the movable piece is formed in the wall, and the pressing portion of the movable piece extends above the upper portion of the wall; a cover plate is arranged on the installation groove and above the contact portion of the movable piece.

11. The key switch with pressure balance function according to claim 9, wherein a PCB (printed circuit board) is arranged at the lower end of the base, the conduction assembly comprises a photoelectric transmitting tube and a photoelectric receiving tube respectively arranged on the PCB and upper ends of the photoelectric transmitting tube and the photoelectric receiving tube are embedded in the base; a bump is arranged downward at the lower end surface of the key cap.

12. The key switch with pressure balance function according to claim 11, wherein a support base is protruded upward provided on an upper end surface of the base, two embedded slots extending into the support base are arranged on a lower end surface of the base for upper ends of the photoelectric transmitting tube and the photoelectric receiving tube to be embedded; an upper end surface of the support base is provided with a through hole, wherein the through hole passes through the lower end surface of the base and is configured for the bump to be movably inserted up and down; the through hole is located between the two embedded slots, and a punching hole is respectively provided between the two embedded slots and the through hole.

13. The key switch with pressure balance function according to claim 2, wherein the key switch further comprises a conduction assembly.

14. The key switch with pressure balance function according to claim 3, wherein the key switch further comprises a conduction assembly.

15. The key switch with pressure balance function according to claim 4, wherein the key switch further comprises a conduction assembly.

16. The key switch with pressure balance function according to claim 5, wherein the key switch further comprises a conduction assembly.

17. The key switch with pressure balance function according to claim 6, wherein the key switch further comprises a conduction assembly.

18. The key switch with pressure balance function according to claim 7, wherein the key switch further comprises a conduction assembly.

19. The key switch with pressure balance function according to claim 8, wherein the key switch further comprises a conduction assembly.
